(19) United States
(12) Patent Application Publication
(10) Pub. No.: US 2005/0037208 A1
(43) Pub. Date: Feb. 17, 2005

(54) Surface-coated A1/Zn steel sheets and surface coating agent

(76) Inventors: Takao Ogino, Hiratsuka-shi (JP); Akira Shono, Yokohama-shi (JP); Yasuhiro Kinoshita, Atsugi-shi (JP); Yoshihiro Hayashi, Yokohama-shi (JP)

Correspondence Address: HENKEL CORPORATION, THE TRIAD, SUITE 200, 2200 RENAISSANCE BLVD., GULPH MILLS, PA, 19406, US

(21) Appl. No.: 10/830,185

(22) Filed: Apr. 22, 2004

(30) Foreign Application Priority Data
Oct. 12, 2002 (WO) PCT/EP02/11448
Oct. 22, 2001 (JP) 2001-323876
Oct. 22, 2001 (JP) 2001-338312

(51) Int. Cl. B32B 15/08; B32B 27/40; C08K 3/10

(52) U.S. Cl. 428/425.8; 524/413

(57) ABSTRACT

A surface-treatment composition for metal sheets, comprising a urethane resin with introduced acid amide groups, having a ratio of urethane bonds to acid amide bonds in the range from 9:1 to 1:9, optionally including chromium or metal compounds selected from the group consisting of Al, Mg, Ca, Zn, Ni, Co, Fe, Zr, Ti, V, W, Mn, and Ce compounds and a silicon compound.

### CROSS-REFERENCE TO RELATED APPLICATIONS

This application claims priority from International Application Number PCT/EP02/11448, published in a non-English language, having an international filing date of Oct. 12 2002, and to JP 2001-323876 filing date Oct. 22, 2001 and to JP 2001-338312 filing date Nov. 2, 2001.

### FIELD OF THE INVENTION

The invention relates in its most general form to surface-treated steel sheets, which are used predominantly in unpainted form for applications in the construction and household appliance sector, and for which, on the surface provided with a covering of aluminum-containing zinc alloy (“Al/Zn alloy”), a coating having outstanding alkali resistance and corrosion resistance is formed.

In a more specific form the invention relates to a chromium-free surface treatment composition which endows Al/Zn steel sheets, i.e., steel sheets with a covering of Al/Zn alloy which are used predominantly in unpainted form for applications in the construction and household appliance sector, with alkali resistance, cold-rollability, and corrosion resistance, and to Al/Zn steel sheets whose surfaces have been treated with this surface coating composition.

### BACKGROUND OF THE INVENTION

Al/Zn steel sheets, especially those with Al contents of 55% in the Al/Zn alloy covering, are used without painting, owing to their outstanding corrosion resistance, for building purposes (e.g., the roofs and outer walls of buildings, supports for plastic greenhouses in agriculture), constructions in engineering (e.g., traffic barriers, sound-insulation walls, drains), household appliances, industrial equipment, and the like. They are therefore required to display an appealing appearance on a long-term basis, without discoloration of their surface. Since, moreover, in applications as construction material they are formed by rolling, they must be cold-rollable, i.e., no coverings must be formed on the rollers. Likewise important is their appearance after cold rolling: the coverings or coatings must be scratch-free and must exhibit outstanding corrosion stability. If the metal sheets are used for applications in the construction sector then, owing to contact with concrete, they are not infrequently exposed to a strongly alkaline, corrosive environment. In these cases too it is required that they exhibit an attractive appearance on a long-term basis, without discoloration of their surfaces.

For an improvement of this theme, in particular for improving the cold-rollability and the corrosion resistance, JP-B2 4-2672 proposes a technology which envisages forming a coating on the surface of an Al/Zn steel sheet by applying a solution which comprises a defined water-soluble or dispersible resin with added hexavalent chromium and whose pH has been adjusted to 3-10.

If Al/Zn steel sheets are used for applications in the construction sector then, owing to contact with concrete, they are not infrequently exposed to a strongly alkaline, corrosive environment. In these cases too they are required to exhibit an attractive appearance on a long-term basis, without discoloration of their surfaces: that is, a high alkali resistance is required of them. Water-soluble or dispersible resins which are stable in the alkaline range generally tend to form salts with alkalis, and hence to reinforce the hydrophilic character of the coating. As a result, even the technology known from JP-B2 4-2672 leads only to surfaces of inadequate alkali resistance. For this reason the technology of the prior art has to date been unable to provide Al/Zn steel sheets with a coating which meets not only the requirement for outstanding alkali resistance but also the requirement for high corrosion stability.

Another example whereby the metal sheets are provided with chromium-containing resin coatings are the surface-treatment processes known from JP 2097278. There it is envisaged, for improving cold-rollability and corrosion resistance, to apply to the surface of Al/Zn steel sheets a solution which in addition to certain water-based or dispersible resins comprises hexavalent chromium in defined amounts and whose pH has been adjusted to 3-10. The Al/Zn steel sheets thus treated exhibit outstanding corrosion resistance particularly in processed areas, but these sheets are problematic from environmental standpoints, since chromium escapes from the coating, particularly in areas of scratches which come about in the course of processing. To date, therefore, there have been no chromiumlessly surface-treated Al/Zn steel sheets available which meet the requirements for outstanding cold-rollability and resistance both to alkali and to corrosion.

### SUMMARY OF THE INVENTION

The inventors have found that deficiencies of the prior art can be resolved by forming, on the surface of Al/Zn steel sheet, a coating composed essentially of resin containing acid amide bonds. By applying a more specific coating, composed essentially of resins defined below, it is possible in addition to achieve the further-reaching object of providing chromium-free surface-treatment compositions and chromium-free surface-treated Al/Zn steel sheets having the desired features.

The invention in its most general form, then, provides a surface-treated steel sheet which is characterized in that on the surface of a steel sheet with a covering of aluminum-containing zinc alloy (“Al/Zn alloy”) a coating is formed which comprises as its principal constituent a resin containing acid amide bonds. The resin containing acid amide bonds that is used is preferably urethane resin containing acid amide bonds. The coating composed essentially of resin containing acid amide bonds may further comprise—as a further component—a chromium compound. The resin/Cr weight ratio, of dry weight of the resin containing acid amide bonds to weight of the chromium compound (calculated as metallic chromium), is preferably in a range from 1 to 200. The chromium content of the coating, calculated as metallic chromium, is preferably in a range from 1 to 100 mg/m2.

### DETAILED DESCRIPTION OF A PREFERRED EMBODIMENT

The Al/Zn steel sheet used as a substrate for the surface-treated steel sheet of the invention comprises steel sheets provided with a covering of Al/Zn alloy (Al content of the alloy covering: 25% to 75% by weight), the most typical of whose known representatives are those with a covering of zinc alloys having an Al content of 55% (Steel sheets having a covering of zinc alloys with Al contents from 50 to 60% by weight are normally referred to as 55% Al/Zn steel sheets (e.g., Galvalume®). This terminology is also followed by the present invention.) The alloy covering of these Al/Zn steel sheets generally has Si contents in orders of magnitude starting at 0.5% by weight of the Al contents. Thus in the alloy covering of 55% Al/Zn steel sheets the Si content is usually about 1 to 3% by weight. The property-enhancing effect caused by the invention is observed significantly for Al/Zn steel sheets having Al contents of 25 to 75% by weight in the alloy covering, but in particular for the abovementioned Al contents of 55%.

The steel sheet of the invention has a coating which is formed on the surface of Al/Zn steel sheet and is composed essentially of resin containing acid amide bonds. In the presence of strong acid, acid amide bonds —CONH— form unstable salts, while in the presence of strong alkalis they adopt the structure —C(OH)N— and hence have an alkali-neutralizing effect. Consequently resins with acid amide bonds are resistant both to acids and to alkalis and exhibit outstanding alkali resistance and corrosion resistance. The surface-treated steel sheet of the invention on whose surface a coating composed essentially of these resins containing acid amide bonds has been formed therefore not only exhibit outstanding cold-rollability and an outstanding appearance after cold rolling but also possess an outstandingly corrosion-resistant and alkali-resistant coating.

The resins containing acid amide bonds are addressed more closely below. The acid amide bonds can be introduced into these resins both in the main chain and in the side chains. Examples include urethane resins with introduced acid amide bonds, acrylic resins with introduced acid amide bonds, ester resins with introduced acid amide bonds, and polyamide resins. Owing to their hydrolysis resistance and wear resistance preference is given to urethane resins with introduced acid amide bonds. In the case of urethane resins with introduced acid amide bonds the ratio of urethane bonds to acid amide bonds in the resin is preferably 9/1 to 1/9. At less than one acid amide bond per 9 urethane bonds, the effect associated with the introduction of the acid amide bonds remains too weak, while at more than 9 acid amide bonds per urethane bond the wear resistance of the urethane resin remains inadequate. The process for the synthesis of the resins containing acid amide bonds is not subject to any particular limitations, though they are preferably synthesized by processes utilized industrially.

The coating-weight of the resin coverings formed from the resins containing acid amide bonds on the surface of the Al/Zn steel sheets is not subject to any particular limitations. It is, however, preferably 0.5 to 5 g/m2. Steel sheet coverings of Al/Zn alloys with Al contents of 25 to 75% by weight have the disadvantage that they are hard and brittle. By coating with the aforementioned resins, however, the detachment of the alloy coverings can be prevented. At a resin coating-weight below 0.5 g/cm2 this detachment-prevention effect remains weak, and also the positive effects in respect of cold-rollability, corrosion resistance, etc remain low. Coating-weights of more than 5 g/m2, on the other hand, are uneconomic, since at that point saturation occurs in the positive effects in respect of detachment prevention, cold-rollability, corrosion resistance, etc.

The coatings formed from the resins containing acid amide bonds may comprise chromium compounds as an additional component. A further improvement in corrosion resistance is anticipated from these compounds, if such is necessary for the envisaged application. The chromium compounds are not subject to particular limitations Preferably, however, compounds are used which contain hexavalent chromium. Examples of chromium compounds of this kind include chromic anhydride, ammonium chromate, potassium dichromate, sodium dichromate, ammonium chromate, potassium chromate, and sodium chromate. The resin/Cr weight ratio, of dry weight of the resin containing acid amide bonds to weight of the chromium compound (calculated as metallic chromium), is preferably in a range from 1 to 200, more preferably 1 to 150, and with particular preference in a range from 10 to 150. At a resin/Cr weight ratio below 1 the chromium-derived corrosion protection effect reaches saturation, and so such weight ratios are uneconomic. At a resin/Cr weight ratio above 200, on the other hand, the effect produced by adding the chromium compounds remains too weak.

When coatings of the invention are formed using chromium the chromium content in the coating, calculated as metallic chromium, is preferably in a range from 1 to 100 mg/m2, more preferably, though, in a range from 3 to 90 mg/m2, and with particular preference in a range from 5 to 80 mg/m2. At chromium contents in the coating of below 1 mg/m2 (calculated as metallic Cr) the effect produced by adding the chromium compounds remains too weak, whereas chromium contents above 100 mg/m2 are uneconomic owing to the saturation which then occurs of the corrosion protection effect of the chromium.

The process for forming the coatings of the invention on the Al/Zn steel sheets is not subject to any particular limitations. The coatings can be applied by any desired processes, such as by coating with rolls (roll coater). Following application the sheets are dried preferably at a temperature (of the sheets) of from 60 to 200° C. with a drying time of within 60 s in, for example, electric ovens, hot-air ovens or induction ovens.

The present invention in its more specific form provides a chromium-free surface-treatment composition which is characterized in that it comprises the following components A, B, and C:
A) a water-based resin containing carboxyl groups and acid amide bonds,
B) one or more metal compounds selected from the group consisting of Al, Mg, Ca, Zn, Ni, Co, Fe, Zr, Ti, V, W, Mn, and Ce compounds,
C) a silicon compound.

Preference is given in this context to chromium-free surface-treatment compositions in which as component A urethane resin or acrylic resin, as component B a Zr compound, and as component C one or more silicon compounds selected from the group consisting of silica, silicic salts, colloidal silicon oxide, and silane coupling reagents are used. Particular preference is given to those chromium-free surface-treatment compositions in which as component C silane coupling reagents are used.

In these surface-treatment compositions the mass ratio (resin/Zr) of component A, water-based resin containing carboxyl groups and acid amide bonds (solid), to Zr in the Zr compounds of component B is preferably in a range from 1 to 300. The weight ratio (resin/Si) of component A to Si in the silane coupling reagent is preferably in a range from 10 to 800.

These surface-treatment compositions of the invention for metal sheets, but particularly for use on Al/Zn steel sheets, are blends of resins of component A with metal compounds of component B and silicon compounds of component C. For their preparation, for example, water can be introduced into a vessel. Subsequently—in this order—the resins of component A, the metal compounds of component B, and the silicon compounds of component C are added and are mixed by stirring, using a propeller stirrer, for instance.

The water-based resins of component A are composed essentially of resins containing carboxyl groups in acid amide bonds and form a coating on the metal surface. As hydrophilic groups, not only do the carboxyl groups promote the emulsion stability, but their presence also improves adhesion on the metal substrate. Moreover, their crosslinking reaction with the metal compounds and silicon compounds present in the composition allows a coating to be formed which has outstanding corrosion resistance and alkali resistance. The carboxylic acid equivalent in the water-based resins for use in the invention is preferably 0.15 to 3.5 mg equivalent/g. The acid amide bonds —CONH— present in the resins take on the structure —C(OH)N— in the presence of strong alkalis and act as acid. Since acid amide bonds react with acid to form unstable salts and neutralize alkali, resins containing acid amide bonds are resistant both to acid and to alkali and therefore offer outstanding corrosion resistance and alkali resistance. The acid amide outstanding corrosion resistance and alkali resistance. The acid amide equivalent in the water-based resins for use in the invention is preferably 0.05 to 3.5 mg equivalent/g. Examples of resins containing carboxyl groups and acid amide bonds include acrylic resins, ester resins, and urethane resins into which carboxyl groups and acid amide bonds have been introduced. These resins are so-called water-based resins, i.e., they are used in aqueous systems, i.e., in a form in which they are emulsified or dissolved in water. From the standpoints of hydrolysis resistance and wear resistance of the coating it is preferred to use urethane resins. The process for the synthesis of the resins is not subject to any particular limitations, although they are preferably synthesized by processes utilized industrially.

As metal salts of the component B added to the water-based resins of component A it is preferred to use one or more metal compounds selected from the group consisting of Al, Mg, Ca, Zn, Ni, Co, Fe, Zr, Ti, V, W, Mn, and Ce compounds. As metal compounds of this kind it is possible to use phosphates, acetates, nitrates, sulfates, carbonates, ammonium carbonates, chlorides, fluorides, ammonium fluorides, fluoride complexes, acetylacetonates, and the like.

If, in particular, Zr compounds are used as metal compounds of component B then the mass ratio (resin/Zr) of component A, water-based resin containing carboxyl groups and acid amide bonds (solid), to Zr in the Zr compounds of component B is preferably in a range from 1 to 300, more preferably in a range from 1 to 200, and with particular preference in a range from 10 to 150. Mass ratios (resin/Zr) of the water-based resin containing carboxyl groups and acid amide bonds (solid) to Zr in the Zr compounds of less than 1 are uneconomic, since there is saturation of the anticorrosive effect produced by the Zr compounds: Corresponding m ass ratios above 300, on the other hand, are disadvantageous owing to the weak anticorrosive effect the Zr compounds then have. The same is true, mutatis mutandis, in those cases where the other metal compounds are employed.

The silicon compounds for addition to the water-based resins of component A are not subject to any particular limitations. Preference is given, however, to using one or more silicon compounds selected from the group consisting of silica, silicic salts, colloidal silicon oxide, and silane coupling reagents. Of these, particular preference is given to using silane coupling reagents such as vinyltrimethoxysilane and gamma-glycidyloxypropyltriethoxysilane.

Where silane coupling reagents are used as silicon compound of component C the mass ratio (resin/Si) of resins of component A containing carboxyl groups and acid amide bonds to Si in the silane coupling agent is preferably in a range from 10 to 800, but more preferably in a range from 50 to 600, and with particular preference in a range from 100 to 400. Mass ratios (resin/Si) of resins of component A containing carboxyl groups and acid amide bonds to Si in the silane coupling reagent of less than 10 are uneconomic, since there is saturation of the anticorrosive effect produced by the silane coupling reagents. Mass ratios (resin/Si) of resins of component A containing carboxyl groups and acid amide bonds to Si in the silane coupling agent of more than 800, on the other hand, are disadvantageous, owing to the weak anticorrosive effect the silane coupling reagents then have. The same is true, mutatis mutandis, in those cases where the other silicon compounds are employed.

Surface-treatment compositions of the invention for metal sheets can be admixed with, as lubricants, substances including molybdenum disulfide, graphite, fluoro resins, and polyolefin waxes. Additionally the coating can be colored using color pigments. Provided the performances of the coating are unaffected it is also possible for foam inhibitors and leveling agents (flow assistants) to be added to the surface-treatment compositions.

The processes for treating the surfaces of Al/Zn steel sheets with surface-treatment compositions of the invention for metal sheets are not subject to any particular limitations; they can be applied in any desired processes, using roll coaters, for example. Following application the metal sheets are dried preferably at a temperature (of the sheets) of from 60 to 200° C. with a drying time of within 60 s in, for example, electric ovens, hot-air ovens or induction ovens.

The weight of the coats formed with the surface-treatment compositions of the invention on Al/Zn steel sheet surfaces (coating-weight) after drying is not subject to any particular restrictions but is preferably in a range from 0.5 to 5 g/m2. Steel sheet coverings of Al/Zn alloys with Al contents of from 25 to 75% by weight have the disadvantage that they are hard and brittle. By coating with the aforementioned resins, however, it is possible to prevent the detachment of the alloy coverings. At a resin coating-weight below 0.5 g/cm2 this detachment prevention effect remains weak, whereas coating-weights of more than 5 g/m2 are uneconomic, since at that point there is saturation of the detachment prevention effect.

The invention further provides in its more specific form chromiumlessly surface-treated Al/Zn steel sheets with outstanding alkali resistance, cold-rollability, and corrosion resistance, which are characterized in that on at least one side, with a coating-weight of from 0.2 to 5.0 g/m2, a coating has been applied which comprises the following components A, B, and C:
A) a water-based resin containing carboxyl groups and acid amide bonds,
B) one or more metal compounds selected from the group consisting of Al, Mg, Ca, Zn, Ni, Co, Fe, Zr, Ti, V, W, Mn, and Ce compounds,
C) a silicon compound.

Preference is given here to using as component A urethane resin or acrylic resin, as component B a Zr compound, and as component C one or more silicon compounds selected from the group consisting of silica, silicic salts, colloidal silicon oxide, and silane coupling reagents. It is particularly preferred to use silane coupling agent as component C.

The mass ratio (resin/Zr) of component A, water-based resin containing carboxyl groups and acid amide bonds (solid), to Zr in the Zr compounds of component B, in the case of these chromium-free, surface-treated Al/Zn steel sheets, is preferably in a range from 1 to 300; the mass ratio (resin/Si) of component A to Si in the silane coupling reagent is preferably in a range from 10 to 800.

The Al/Zn steel sheets used as substrates are subject to the elucidations given earlier on above in connection with the general form of the invention.

In the text below the invention is illustrated by working examples and comparative examples, without limitation of the subject matter of the invention to the examples given. In the examples figures in parts and % refer always to the weight.

### WORKING EXAMPLES

Production of Metal Test Sheets

1. Materials

5% Al/Zn steel sheet (GF=Galfan®)

55% Al/Zn steel sheet (GL=Galvalume®)

2. Degreasing

The metal test sheets were degreased with Fine Cleaner® 4336 (registered trademark of Nihon Parkerizing (Japan), described as a silicate-based alkaline degreasing agent) at a concentration of 20 g/l, temperature 60° C., 20 seconds spraying, thereafter the sheets were rinsed with tap water.

### An Embodiment of the Invention Optionally Containing Chromium

A3. Synthesis of the Resins

A3.1 Urethane Resin Containing Acid Amide Bonds 100 parts of polyester resin (number-average molecular weight: 1000, terminal carboxyl groups), 100 parts of diol compound (number-average molecular weight: 1000, terminal hydroxyl groups), 15 parts of 2,2-dimethylolpropionic acid, 100 parts of dicyclohexylmethane diisocyanate, 100 parts of N-methyl-2-pyrrolidone were reacted to form a prepolymer and this product was dispersed in deionized water.

A3.2 Acrylic Resin Containing Acid Amide Bonds

Following reaction of 10 parts of acrylic acid with 5 parts of isophorone diisocyanate 25 parts of styrene, 10 parts of methyl methacrylate, 20 parts of butyl methacrylate, and 30 parts of 2-ethylhexyl acrylate were added. Dropwise introduction of this mixture into an aqueous solution containing surfactant gave acrylic resin.

A3.3 Ethylene-Modified Acrylic Resin An aqueous ethylene-acrylic acid copolymer dispersion was used.

A4. Preparation of the Solution for the Surface Treatment

At room temperature the resins listed in table A1 (solids concentration in each case 25%) and the chromium compounds listed in table A2 (Cr concentration, calculated as metallic Cr, in each case 5%) were added in this order to distilled water and were mixed by stirring with a propeller stirrer. In this way the solutions C1˜C8 and D1˜D2 for the surface treatment were prepared.

TABLE A1

| No. | Resin | Acid amide bonds |
|---|---|---|
| A1 | Urethane resin | Yes |
| A2 | Acrylic resin | Yes |
| A3 | Ethylene-modified acrylic | No |
| | resin | |

TABLE A2

| | | Cr (VI) |
|---|---|---|
| No. | Chromium compound | \overline{Cr (III) + Cr (VI)} |
| B1 | Cr (III) + Cr (VI) | 0.7 |
| B3 | Cr (VI) | 1.0 |

TABLE A3

| | Composition (parts by weight) | | |
|---|---|---|---|
| No. | Resin | Cr compound | Resin/Cr |
| C1 | A1 (95) | B1 (5) | 95 |
| C2 | A1 (95) | B2 (5) | 95 |
| C3 | A1 (92) | B1 (8) | 58 |
| C4 | A2 (85) | B2 (15) | 18 |
| C5 | A2 (75) | B1 (25) | 15 |
| C6 | A2 (97) | B2 (3) | 162 |
| C7 | A1 (100) | — | — |
| C8 | A2 (100) | — | — |
| D1 | A3 (95) | B2 (5) | 95 |
| D2 | A3 (85) | B2 (15) | 28 |

Production of the Surface-Treated Steel Sheets

The surface-treatment compositions C1˜C8 and D1˜D2 were applied using a bar coater to the surfaces of the GL and GF test sheets in such a way that the coating-weights and Cr application rates indicated in tables A4 (working examples 1 to 12) and AS (comparative examples 1 to 4) were obtained. This was followed by drying at an ambient temperature of 240° C. The coating-weights (g/m²) were adjusted by way of the corresponding choice of the solids concentration in the surface-treatment compositions. Thereafter the corrosion resistance (of the flat area) and alkali resistance (flat area) of the surface-treated steel sheets was evaluated in accordance with the method described below for evaluating the coating performances. The results are collated in tables A4 A5.

TABLE A4
Working examples

| | | | Coating- | Cr | | |
|---|---|---|---|---|---|---|
| | | | weight | Applied | Resistance | |
| No. | Substrate | STC | (g/m2) | (mg/m2) | Corrosion | Alkali |
| 1 | GL | C1 | 1.5 | 15.8 | 1 | 1 |
| 2 | GL | C2 | 1.5 | 15.8 | 1 | 1 |
| 3 | GL | C3 | 1.5 | 25.9 | 1 | 1 |
| 4 | GL | C4 | 1.5 | 53.6 | 1 | 1 |
| 5 | GL | C5 | 1.5 | 100.0 | 1 | 1 |
| 6 | GL | C6 | 1.5 | 9.3 | 1 | 1 |
| 7 | GL | C7 | 1.5 | 0 | 2 | 1 |
| 8 | GL | C8 | 1.5 | 0 | 2 | 1 |
| 9 | GL | C1 | 0.5 | 5.1 | 1 | 1 |
| 10 | GL | C2 | 3.0 | 31.9 | 1 | 1 |
| 11 | GF | C3 | 1.5 | 25.9 | 1 | 1 |
| 12 | GF | C4 | 1.5 | 53.6 | 1 | 1 |

(Abbreviations: STC=surface-treatment composition No.; corrosion resistance=corrosion resistance of the flat area)

TABLE A5
Comparative examples

| | | | Coating- | Cr | | |
|---|---|---|---|---|---|---|
| | | | weight | Applied | Resistance | |
| No. | Substrate | STC | (g/m2) | (mg/m2) | Corrosion | Alkali |
| 1 | GL | D1 | 1.5 | 15.8 | 3 | X |
| 2 | GL | D2 | 1.5 | 53.6 | 2 | X |
| 3 | GL | D1 | 3.0 | 31.6 | 2 | X |
| 4 | GL | D2 | 5.0 | 178.7 | 2 | X |

(Abbreviations: as for table A4)

Method of Evaluating the Coating Performances

Corrosion Resistance in the Flat Area

After 240 h of salt spray test in accordance with JIS-Z-2371 the rusting was inspected and was evaluated in accordance with the following criteria:
1 No rusting
2 Rusting over less than 10% of the total area
3 Rusting over 10% to less than 30% of the total area
x Rusting over 30% or more of the total area

Alkali Resistance

The test sheets were immersed in 1% strength aqueous NaOH solution for 5 hours and the condition of the coating was compared before and after immersion with one another. Evaluation was made in accordance with the following criteria:
1 Appearance unchanged
2 Fraction of discolored area less than 10% of the total area
3 Fraction of discolored area 10% to less than 30% of the total area
X Fraction of discolored area 30% or more of the total area

As demonstrated by tables A4 and A5, the surface-treated steel sheets of the invention exhibit both good corrosion resistance and good alkali resistance. In contrast, in the case of the surface-treated steel sheets of the comparative examples, which do not embody the features of the invention, either deficient corrosion resistance or deficient alkali resistance is found.

Al/Zn steel sheets of the invention with a coating composed of certain (above-described) resins formed on their surfaces exhibit both outstanding corrosion resistance and outstanding alkali resistance. Additionally the steel sheets of the invention have good cold-rollability (i.e., no buildup of coverings on the rolls) and have an outstanding appearance after cold rolling. They are therefore of high utility in industry.

### A Chromium Free Embodiment of the Invention

B3. Synthesis of the Resins

B3.1 Urethane Resin Containing Acid Amide Bonds

100 parts of polyester resin (number-average molecular weight: 1000, terminal carboxyl groups), 100 parts of diol compound (number-average molecular weight: 1000, terminal hydroxyl groups), 15 parts of 2,2-dimethylolpropionic acid, 100 parts of dicyclohexylmethane diisocyanate, 100 parts of N-methyl-2-pyrrolidone were reacted to form a prepolymer and this product was dispersed in deionized water. Characteristics of the urethane resin: carboxylic acid equivalent: 0.75 mg equivalent/g, acid amide equivalent: 0.5 mg equivalent/g.

B3.2 Acrylic Resin Containing Acid Amide Bonds

Following reaction of 10 parts of acrylic acid with 5 parts of isophorone diisocyanate 25 parts of styrene, 10 parts of methyl methacrylate, 20 parts of butyl methacrylate, and 30 parts of 2-ethylhexyl acrylate were added. Dropwise introduction of this mixture into an aqueous solution containing surfactant gave acrylic resin. Characteristics of the urethane resin: carboxylic acid equivalent: 0.75 mg equivalent/g, acid amide equivalent: 0.5 mg equivalent/g. At room temperature the resins listed in table B1, the metal compounds listed in table B2, and the silicon compounds listed in table B3 were added in this order to distilled water and were mixed by stirring with a propeller stirrer. In this way the surface-treatment compositions listed in table B4 were prepared.

TABLE B1

| | | | Carboxyl |
|---|---|---|---|
| No. | Resin | Acid amide bonds | groups |
| A1 | Urethane resin | Yes | Yes |
| A2 | Acrylic resin | Yes | Yes |
| A3 | Ethylene-modified | No | Yes |
| | acrylic resin | | |

(solids concentration in each case 25%)

TABLE B2

| No. | Metal compound |
|---|---|
| B1 | Zirconium ammonium carbonate |
| B2 | Zirconium ammonium fluoride |
| B3 | Titanium acetylacetonate |
| B4 | Ammonium vanadate |
| B5 | Cobalt carbonate |

TABLE B3

| No. | Silicon compound |
|---|---|
| C1 | Vinyltrimethoxysilane |
| C2 | gamma-Glycidyloxypropyltriethoxysilane |
| C3 | Colloidal silicon oxide |
| C4 | Potassium silicate |

TABLE B4

| | Composition (parts by weight) | | | | | | | |
|---|---|---|---|---|---|---|---|---|
| | | | Me | | Si | | | |
| | | | Com- | | Com- | | Resin/ | Resin/ |
| No. | Resin | | pound | | pound | | Metal | Si |
| D1 | A1 | 100 | B1 | 2 | C1 | 0.2 | 50 | 500 |
| D2 | A1 | 300 | B2 | 3 | C1 | 1 | 100 | 300 |
| D3 | A1 | 150 | B3 | 1 | C2 | 0.75 | 150 | 200 |
| D4 | A1 | 700 | B4 | 3.5 | C2 | 1 | 200 | 700 |
| D5 | A1 | 100 | B5 | 1 | C2 | 1 | 100 | 100 |
| D6 | A1 | 150 | B1 | 1 | C3 | 0.5 | 150 | 300 |
| D7 | A1 | 150 | B1 | 1 | C4 | 0.75 | 150 | 200 |
| D8 | A2 | 300 | B1 | 3 | C1 | 1 | 100 | 300 |
| D9 | A2 | 100 | B2 | 2 | C2 | 0.25 | 50 | 400 |
| D10 | A1 | 100 | B2 | 0.25 | C1 | 0.2 | 400 | 500 |
| D11 | A1 | 100 | B2 | 2 | C1 | 0.1 | 50 | 1000 |
| D12 | A1 | 100 | B1 | 1 | — | — | 100 | — |
| D13 | A1 | 100 | — | — | C2 | 0.5 | — | 200 |
| D14 | A3 | 100 | B1 | 2 | C1 | 0.2 | 50 | 500 |
| D15 | A3 | 150 | B2 | 1 | C2 | 0.5 | 150 | 300 |

B5. Production of the Surface-Treated Steel Sheets

The surface-treatment compositions described were applied using a bar coater to the surfaces of the test sheets, then dried at an ambient temperature of 240° C. The coating-weights (g/m²) were adjusted by way of the corresponding choice of the solids concentration in the surface-treatment compositions.

Evaluation of the Coating Performances

Corrosion in the flat area

After 240 h of salt spray test in accordance with JIS-Z-2371 the rusting was inspected and was evaluated in accordance with the following criteria:
1 No rusting
2 Rusting over less than 10% of the total area
3 Rusting over 10% to less than 30% of the total area
X Rusting over 30% or more of the total area

Alkali resistance

The test sheets were immersed in 1% strength aqueous NaOH solution for 5 hours and the condition of the coating was compared before and after immersion with one another. Evaluation was made in accordance with the following criteria:
1 Appearance unchanged
2 Fraction of discolored area less than 10% of the total area
3 Fraction of discolored area 10% to less than 30% of the total area

X Fraction of discolored area 30% or more of the total area

TABLE B5
(Results/working examples)

| | | Coating- | | | |
|---|---|---|---|---|---|
| | | weight | | Resistance | |
| No. | STC | (g/m2) | Substrate | Corrosion | Alkali |
| 1 | D1 | 2.0 | GL | 1 | 1 |
| 2 | D2 | 2.0 | GL | 1 | 1 |
| 3 | D3 | 2.0 | GL | 1 | 1 |
| 4 | D4 | 2.0 | GL | 1 | 1 |
| 5 | D5 | 2.0 | GL | 1 | 1 |
| 6 | D6 | 2.0 | GL | 2 | 2 |
| 7 | D7 | 2.0 | GL | 2 | 2 |
| 8 | D8 | 2.0 | GL | 1 | 1 |
| 9 | D9 | 2.0 | GL | 1 | 1 |
| 10 | D2 | 0.5 | GL | 2 | 2 |
| 11 | D2 | 2.0 | GF | 1 | 1 |
| 12 | D3 | 2.0 | GF | 1 | 1 |

(Abbreviations:
STC = surface-treatment composition No.;
corrosion resistance = corrosion resistance of the flat area)

TABLE B6
(Results/comparative examples)

| | | Coating- | | | |
|---|---|---|---|---|---|
| | | weight | | Resistance | |
| No. | STC | (g/m2) | Substrate | Corrosion | Alkali |
| 1 | D10 | 2.0 | GL | 3 | X |
| 2 | D11 | 2.0 | GL | 3 | X |
| 3 | D12 | 2.0 | GL | 3 | X |
| 4 | D13 | 2.0 | GL | 3 | 3 |
| 5 | D14 | 2.0 | GL | X | X |
| 6 | D15 | 2.0 | GF | X | X |
| 7 | D1 | 0.2 | GL | 3 | X |

The results of testing (inventive working examples and comparative examples) are collated in tables B5 and B6. The surface-treated steel sheets of the invention from working examples Nos. 1 to 12 exhibit both good corrosion resistance and good alkali resistance. In contrast, in the case of the surface-treated steel sheets of comparative examples Nos. 1 to 7, which do not embody the features of the invention, either deficient corrosion resistance or deficient alkali resistance is found.

Treatment of the surfaces of metal sheets, particularly Al/Zn steel sheets, with surface-treatment compositions of the invention endows these sheets with outstanding corrosion resistance and alkali resistance. Since, moreover, these sheets exhibit outstanding cold-rollability, the invention has a high industrial utility. Since they are chromium-free, moreover, there is no environmental burden either.

1. A surface-coated Al/Zn steel sheet comprising a surface coating having as its principal constituent a urethane resin comprising acid amide groups, said resin having a ratio of urethane bonds to acid amide bonds in the range from 9:1 to 1:9.

2. The surface-coated Al/Zn steel sheet of claim 1, wherein the coating further comprises a chromium compound.

3. The surface-coated Al/Zn steel sheet of claim 2, wherein the resin/Cr weight ratio, of dry weight of the resin comprising acid amide bonds to weight of the chromium compound, calculated as metallic chromium, is in a range from 1 to 200.

4. The surface-coated Al/Zn steel sheet of claim 2, wherein the chromium compound is present in the coating in a range from 1 to 100 mg/m², calculated as metallic chromium.

5. The surface-coated Al/Zn steel sheet of claim 1 with outstanding alkali resistance, cold-rollability, and corrosion resistance, comprising:
a chromium-free surface coating and having on at least one surface a coating which comprises:
A) a urethane resin with acid amide groups, with a ratio of urethane bonds to acid amide bonds in the range from 9:1 to 1:9.
B) one or more metal compounds selected from the group consisting of Al, Mg, Ca, Zn, Ni, Co, Fe, Zr, Ti, V, W, Mn, and Ce compounds, and
C) a silicon compound;
wherein said coating-weight is from 0.2 to 5.0 g/m².

6. The surface-coated Al/Zn steel sheet of claim 5, wherein component B comprises a Zr compound, and component C comprises one or more silicon compounds selected from the group consisting of silica, silicic salts, colloidal silicon dioxide, and silane coupling reagents.

7. The surface-coated Al/Zn steel sheet of claim 6, wherein component C comprises one or more silane coupling reagents.

8. The surface-coated Al/Zn steel sheet of claim 7, wherein component B comprises one or more Zr compounds and the mass ratio of component A solids to Zr in the Zr compounds of component B is in a range from 1 to 300.

9. The surface-coated Al/Zn steel sheet of claim 8, wherein the weight ratio of component A solids to Si in the silane coupling reagent is in a range from 10 to 800.

10. A chromium-free surface-treatment composition for metal sheets, which comprises:
A) a urethane resin with introduced acid amide groups, with a ratio of urethane bonds to acid amide bonds in the range from 9:1 to 1:9,
B) one or more metal compounds selected from the group consisting of Al, Mg, Ca, Zn, Ni, Co, Fe, Zr, Ti, V, W, Mn, and Ce compounds, and
C) a silicon compound;
said surface-treatment composition being chromium-free.

11. The chromium-free surface-treatment composition for metal sheets of claim 10, wherein component B comprises a Zr compound, and component C comprises one or more silicon compounds selected from the group consisting of silica, silicic salts, colloidal silicon dioxide, and silane coupling reagents.

12. The chromium-free surface-treatment composition for metal sheets of claim 11, wherein component C comprises one or more silane coupling reagents.

13. The chromium-free surface-treatment composition for metal sheets of claim 12, wherein component B comprises one or more Zr compounds and the mass ratio of component A solids to Zr in the Zr compounds of component B is in a range from 1 to 300.

14. The chromium-free surface-treatment composition for metal sheets of claim 13, wherein the weight ratio of component A solids to Si in the silane coupling reagent is in a range from 10 to 800.

15. The surface-coated Al/Zn steel sheet of claim 5, wherein component B comprises one or more Zr compounds and the mass ratio of component A solids to Zr in the Zr compounds of component B is in a range from 1 to 300.

16. The chromium-free surface-treatment composition for metal sheets of claim 10, wherein component B comprises one or more Zr compounds and the mass ratio of component A solids to Zr in the Zr compounds of component B is in a range from 1 to 300.

17. A chromium-free surface-treatment composition for metal sheets, which comprises:
A) an acrylic resin with introduced acid amide groups,
B) a Zr compound, and
C) one or more silicon compounds selected from the group consisting of silica, silicic salts, colloidal silicon dioxide, and silane coupling reagents
said surface-treatment composition being chromium-free.

18. The chromium-free surface-treatment composition for metal sheets of claim 17, wherein component C comprises one or more silane coupling reagents.

19. The chromium-free surface-treatment composition for metal sheets of claim 18, wherein the mass ratio of component A solids to Zr in the Zr compounds of component B is in a range from 1 to 300 and the weight ratio of component A solids to Si in the silane coupling reagent is in a range from 10 to 800.
